(19) United States
(12) Patent Application Publication
(10) Pub. No.: US 2008/0159636 A1
(43) Pub. Date: Jul. 3, 2008

(54) ENCODING APPARATUS AND ENCODING METHOD

(75) Inventors: Emi Maruyama, Yokohama-shi (JP); Minoru Ohta, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/959,937

(22) Filed: Dec. 19, 2007

(30) Foreign Application Priority Data
Dec. 27, 2006 (JP) 2006-353184

(51) Int. Cl. G06K 9/36; G06K 9/46

(52) U.S. Cl. 382/232; 375/E07.267

(57) ABSTRACT

According to one embodiment, an encoding apparatus which encodes video data in accordance with MPEG4 AVC, the encoding apparatus includes a GOVU configuration determining unit configured to determine a group of video access units configuration of the video data, such that a last one of a plurality of group of video access units contained in each of a plurality of selectable content items in the video data contains a predetermined number of pictures by adjusting the number of pictures contained in a second last group of video access units, and an encoding unit configured to encode the video data based on the group of video access units configuration determined by the GOVU configuration determining unit.

### CROSS-REFERENCE TO RELATED APPLICATIONS

This application is based upon and claims the benefit of priority from Japanese Patent Application No. 2006-353184, filed Dec. 27, 2006, the entire contents of which are incorporated herein by reference.

### BACKGROUND

1. Field

One embodiment of the present invention relates to an encoding apparatus and an encoding method, and in particular, to an encoding apparatus and an encoding method for video content.

2. Description of the Related Art

When one movie is recorded on an optical disk such as DVD, plural versions of the movie may be recorded on the optical disk. For example, in addition to a certain movie in initial playback setting (hereinafter simply referred to as “standard scenes”), a plurality of alternative and short scenes may be recorded on the optical disk. And the alternative scenes playback in place of some scenes in the movie. Such a function is called a multi playback path function.

Examples of the alternative version by the above means include version containing no inappropriate scene for children such as violent scenes, a version containing scenes not included for general release, and versions prepared on a country-by-country basis. Furthermore, for example, three versions of a certain movie, a general release version, an uncut version, and a special version representing a director's cut, may be recorded on the optical disk by providing the corresponding multi playback path for required scenes.

To play an optical disk on which plural versions of a movie are recorded, a user can, for example, operate a remote controller to select one of the plural versions from a menu. Whichever version is selected by the user, different data need to be combined together to seamlessly reproduce videos and sounds.

Various techniques for combining different data together have been proposed. For example, one technique decomposes each encoded video data stream in an input transport stream into original elementary streams, stores the resulting streams in storage means, analyzes the coding rate of those of the plurality of elementary streams which are to be combined together, and on the basis of the analysis, combines two unconnected streams in original and inserts a desired amount of data into each combination point between two streams to generate a combined video data stream (see, for example, Jpn. Pat. Appln. KOKAI Publication No. 11-261958).

DVD standards adopt MPEG2 (MPEG: Moving Picture Experts Group) as a video compression standard. In MPEG2, a video bitstream is composed of a plurality of groups of pictures (GOPs). A GOP is composed of a plurality of pictures (access units). The pictures constituting a GOP are classified into three types, pictures called I-pictures and encoded by intra-screen predictions, pictures called P-pictures and encoded by forward inter-screen predictions (predictions based on one past I- or P-picture), and pictures called B-pictures and encoded by bidirectional inter-screen predictions (predictions based on one past I- or P-picture and one future I- or P-picture).

In many cases, the number of pictures in GOP does not vary at any points except specific points and the number of pictures determined in encoder specifications continues. Typical specific points are DVD chapter points. Chapters are a plurality of units into which the entire movie to be reproduced is separated. The chapter point is the start point of each chapter. The chapter point is desired to be randomly accessible. When the chapter point is an I-picture, reproduction can be started with the I-picture without the need to decode the preceding or following picture.

In MPEG2, if the video content is multi playback path, the number of pictures need not be the same in all of the last GOP of the standard scenes and the last GOPs of the alternative scenes at a branch point or a junction point. Consequently, the remainder of the pictures to be encoded, the number of which is not a multiple of the number of pictures determined to correspond to one GOP, is often assigned to the last GOP of each alternative scenes without any special consideration.

On the other hand, the HD DVD and Blu-Ray standards adopt MPEG4 AVC/H.264 (hereinafter simply referred to as “MPEG4 AVC”) as a video encoding scheme. The HD DVD standard specifies that a video bitstream based on MPEG4 AVC is composed of units defined in the HD DVD standard and called groups of video access units (GOVUs). One GOVU is composed of a kind of packets called network abstraction layer (NAL) units each of at least 1 byte.

A leading picture of the GOVU has data preceding picture data as a header and including an access unit delimiter, sequence parameter set (SPS), supplemental enhancement information (SEI) (1), picture parameter set (PPS), and SEI (2) arranged in this order. The second and succeeding pictures each have an access unit delimiter, PPS, SEI (3), and picture data arranged in this order. SEI (1) of the leading picture includes the buffering period SEI. SEI (2) includes the picture timing SRI. SEI (3) in each of the second and succeeding pictures is the picture timing SEI and not the buffering period SEI. Both the buffering period SEI and the picture timing SEI are present to transmit additional information for buffer management.

MPEG4 AVC uses not only I-pictures encoded by intra-screen predictions, P-pictures encoded by forward inter-screen predictions, and B-pictures encoded by prediction on two pictures regardless of whether the pictures are past or future ones as opposed to MPEG2, but also IDR pictures. The IDR pictures serve as I-pictures in MPEG2. In actuality, in MPEG4 AVC, pictures preceding an I-picture can be used for a prediction. This may prevent correct reproduction even though decoding is started with the I-picture. The presence of an IDR picture prevents a picture preceding the IDR picture from being used for a prediction. In actuality, pictures such as chapter points to be randomly accessed are IDR pictures.

When other pictures are encoded, a picture used for a prediction is called a reference picture. Pictures not used for predictions are called non-reference pictures. MPEG4 AVC specifies the number of pictures contained in one GOVU such that the total time required to display this GOVU is at most 0.6006 seconds. Thus, obviously, video content such as a movie is composed of a plurality of GOVUs. A GOVU is specified to be composed of a plurality of pictures (access units) as in the case of a GOP.

MPEG4 AVC allows information on the number of pictures in one GOVU to be written to a buffer management information area (cpb_removal_delay) in the leading picture of the succeeding GOVU. This is essential for the HD DVD standard. Thus, if video content in accordance with the HD DVD standard has multi playback path and a user selectable scenes (a standard or an alternative scenes of the video content) playbacks before another standard scenes, a difference in the number of pictures in the last GOVU between two user selectable scenes violates the H.264 standard. This may also result in reproduction problems such as a difficulty in seamless reproduction. The technique described in Jpn. Pat. Appln. KOKAI Publication No. 11-261958 adjusts the amount of data in the storage means but cannot deal with the above problems.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary flowchart illustrating a process executed by a hypothetical decoder defined in the MPEG4 AVC standard;

FIG. 2 is an exemplary schematic diagram illustrating cpb_removal_delay observed when input video data is a interlaced video;

FIG. 3 is an exemplary schematic diagram illustrating cpb_removal_delay observed when the input video data is a movie;

FIG. 4 is an exemplary schematic diagram illustrating the configuration of a video content having a plurality of reproduction paths;

FIG. 5 is an exemplary block diagram schematically showing the configuration of an encoding apparatus in accordance with an embodiment of the present invention;

FIG. 6 is an exemplary block diagram schematically showing the configuration of a GOVU configuration determining unit shown in FIG. 5;

FIG. 7 is an exemplary schematic diagram illustrating the GOVU configuration of each alternative version determined by a setting unit of the GOVU configuration determining unit; and

FIG. 8 is an exemplary flowchart illustrating an encoding method in accordance with an embodiment of the present invention.

### DETAILED DESCRIPTION

Various embodiments according to the invention will be described hereinafter with reference to the accompanying drawings. In general, according to one embodiment of the invention, an encoding apparatus which encodes video data in accordance with MPEG4 AVC, the encoding apparatus includes a GOVU configuration determining unit configured to determine a group of video access units configuration of the video data, such that a last one of a plurality of group of video access units contained in each of a plurality of selectable content items in the video data contains a predetermined number of pictures by adjusting the number of pictures contained in a second last group of video access units, and an encoding unit configured to encode the video data based on the group of video access units configuration determined by the GOVU configuration determining unit.

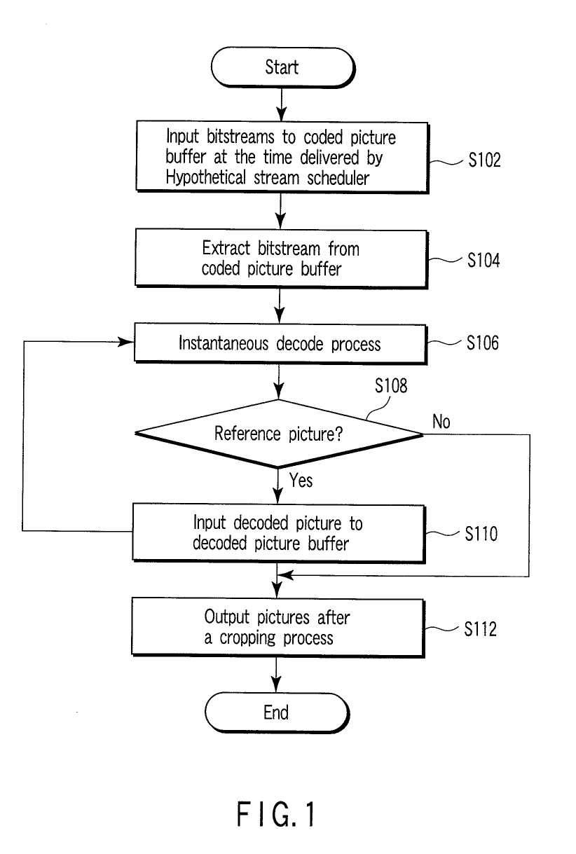

First, with reference to FIG. 1, a hypothetical decoder model in MPEG4 AVC will be described.

MPEG4 AVC specifies a hypothetical reference decoder. The hypothetical reference decoder is a hypothetical model of operations of a decoder. It specifies especially the state of a decoder buffer. An encoder needs to generate a bitstream so as not to compromise the hypothetical reference decoder. The decoder (for example, a decode circuit in an HD DVD player) also needs to conform to the hypothetical reference decoder.

The hypothetical reference decoder includes two buffers, that is, a coded pictures buffer (CPB) and a decoded picture buffer (DPB). Bitstreams are stored in the coded picture buffer before being input to the decoder. Pictures decoded by the decoder are stored in the decoded picture buffer.

FIG. 1 is an exemplary flowchart illustrating a process executed by a hypothetical reference decoder defined in the MPEG4 AVC standard. First, a bit stream is input to the coded picture buffer at a specified arrival time by a hypothetical stream scheduler (HSS) (block S102).

A given time (cpb_removal_delay) later, the input bitstream is instantaneously extracted from the coded picture buffer (block S104). The extracted bitstream is instantaneously decoded by the hypothetical decoder (block S106). The model determines whether or not the decoded data (picture) is a reference picture (block S108).

If the decoded picture is the reference picture and output time of DPB is not same as CPB removal time (YES in block S108), the picture is input to the decoded picture buffer instantaneously (block S110). At the later of a given time (dpb_output_delay) or the time that reference picture is marked “unused for reference”, the input picture is extracted from the decoded picture buffer. The input picture is subjected to a cropping process and then output (block S112). The reference picture stored in the decode picture buffer is utilized to decode subsequently input pictures (the process proceeds from block S110 to block S106). On the other hand, if the decoded picture is a non-reference picture (NO in block S108), the picture is instantaneously output after the decoding. That is, the picture is output after the cropping process (block S112).

The cropping process refers to a process of removing upper, lower, right, or left pixels in accordance with the form of an image to be output. Furthermore, cpb_removal_delay and dpb_output_delay are described in supplemental enhancement information (SEI) for picture timing.

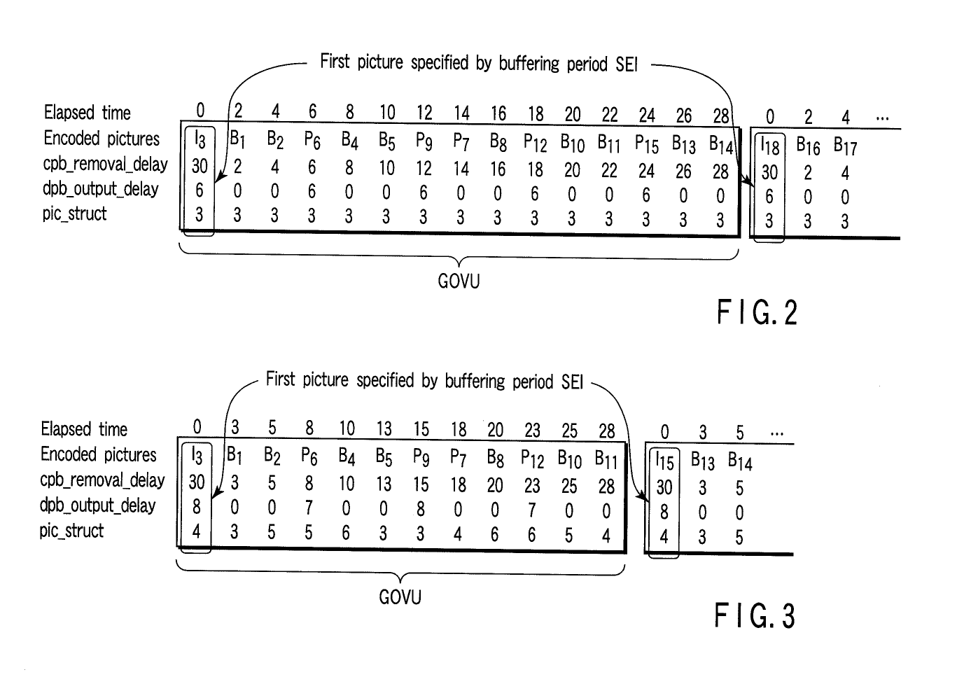

Now, with reference to FIGS. 2 and 3, cpb_removal_delay will be described in conjunction with a specific example.

FIG. 2 is an exemplary schematic diagram illustrating cpb_removal_delay observed when the input video data is an interlaced video. In FIG. 2, the numbers (0, 2, 4, . . . ) in the uppermost stage indicate the amounts of time having elapsed from a reference (0) set to correspond to the timing at which the leading picture (in the example shown in FIG. 2, I₃ or I₁₈) of the GOVU is input to the coded picture buffer. The relevant unit is a clock tick (CT). CT is determined by calculating num_units_in_tick/time_scale using num_units_in_tick and time_scale described in a video usability information (VUI) parameter. For example, when a frame rate during output is 29.97 Hz, that is, a standard for NTSC interfacing (field frequency is 54.94 Hz), CT=10001/60000-16.68 ms.

The combination of alphabets and numbers (I₃, B₁, B₂, . . . ) in the second stage from the top is an example of a list of pictures in the order of encoding. Reference symbols I_{X}, P_{X}, and B_{X} denote an I-, P-, and B-picture, respectively. The range from I₃ to B₁₄ corresponds to one GOVU.

The numbers (30, 2, 4, . . . ) in the third stage from the top indicate cpb_removal_delay. In MPEG4 AVC, cpb_removal_delay refers to a difference in time between a reference time when a picture specified on the basis of a buffering period SEI is extracted from the coded picture buffer and a time when the current picture is extracted from the coded picture buffer. In the HD DVD standard, the leading picture of the GOVU (in the example in FIG. 2, I₃ or I₁₈) necessarily contains the buffering period SEI.

The numbers (6, 0, 0, . . . ) in the fourth stage from the top indicate dpb_output_delay for each picture. dpb_output_delay corresponds to the amount of time from the input of a picture to the decoded picture buffer until the picture is extracted from the decoded picture buffer. The unit of dpb_output_delay is CT.

The numbers (3, 3, 3, . . . ) in the lowermost stage indicate pic_struct. pic_struct is described in a picture timing SEI and indicates a field configuration to be displayed after decoding. For example, “3” indicates that the field order is top-bottom. Both input data and display output data (for example, player output circuits, or the like) are based on an interlace scheme at same frame rate, keeping the number of fields unchanged.

FIG. 3 is an exemplary schematic diagram illustrating cpb_removal_delay observed when the input data is a movie). In FIG. 3, as in FIG. 2, the uppermost stage indicates the amounts of time having elapsed from the reference (0) set to correspond to the timing at which the leading picture (in the example shown in FIG. 3, I₃ or I₁₅) of the GOVU is input to the coded picture buffer.

The combination of alphabets and numbers (I₃, B₁, B₂, . . . ) in the second stage from the top indicate a list of pictures in the order of encoding. The numbers (30, 3, 5, . . . ) in the third stage from the top indicate cpb_removal_delay. The numbers (8, 0, 0, . . . ) in the fourth stage from the top indicate dpb_output_delay for each picture. The numbers (4, 3, 5, . . . ) in the lowermost stage indicate pic_struct. “4”, “5”, and “6” indicate that the field order is bottom-top, top-bottom-top, and bottom-top-bottom, respectively.

As seen in the lowermost stage in FIG. 3, unlike the interlaced video, the movie has the field combinations “top-bottom-top” and “bottom-top-bottom”. The display output video is 30 frames per second, whereas the movie is recorded at 24 frames per second. Consequently, the frame period of the movie is four-fifths of that of the interlaced video. Thus, to encode data on the movie, a process is required for setting the number of pictures to be encoded the same as that of display output videos (change 24 to 30 frames per second). This is called a 3:2 pull-down process.

As shown in FIGS. 2 and 3, cpb_removal_delay specified by the buffering period SEI of the leading picture (in FIG. 2, I₁₈, and in FIG. 3, I₁₅) is “30”. This means that display time is delayed by 30 CT from the input of the leading picture (the picture specified by the buffering picture SEI; 13 in FIGS. 2 and 3) of one GOVU to the coded picture buffer after the leading picture of the preceding GOVU is input to the coded picture buffer.

If the input data is a video based on the interlace scheme, the expression “the number of pictures in GOVU (for example, 15)×2×CT” can be given. On the other hand, if the input data is a movie, the 3:2 pull-down process is executed. Consequently, the expression “the number of pictures in GOVU (for example, 12)×2×5/4×CT” can be given. Regardless of whether the input data is a video or a movie, the cpb_removal_delay for the pictures specified by the buffering period SEI requires information on the number of pictures in the preceding GOVU.

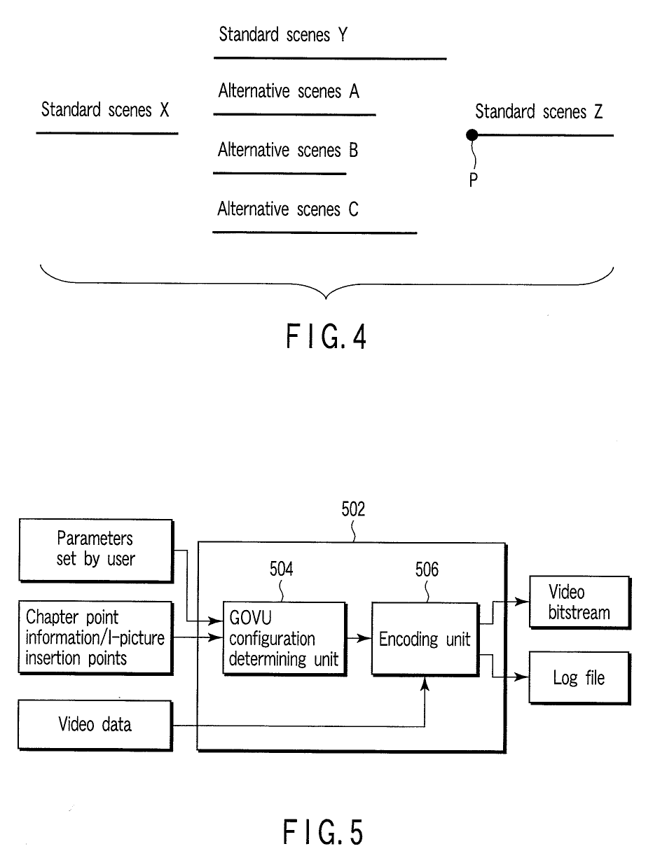

Now, with reference to FIG. 4, description will be given of a decode process executed on an example of specific video content.

FIG. 4 is an exemplary schematic diagram illustrating the configuration of video content (movie and an interlaced video source) having a plurality of reproduction paths (a plurality of selectable content items). The term “plurality of selectable content items” refers to a plurality of selectable content items to be combined into a single content item. In FIG. 4, standard scenes Y, alternative scenes A, alternative scenes B, and alternative scenes C correspond to the plurality of selectable content items and are to be combined into a single content item, that is, standard scenes Z.

The video content shown in FIG. 4 allows standard scenes X to be reproduced and then allows one of standard scenes Y, alternative scenes A, alternative scenes B, and alternative scenes C to be selected for reproduction. After the selected content is reproduced, the process proceeds from point P in FIG. 4 to reproduction of standard scenes Z. Regardless of the selected content, the process proceeds to the reproduction of standard scenes Z after the reproduction of that content.

For example, by selecting a definitive scenes instead of a general release version, the user can change the reproduction order from “standard scenes X→standard scenes Y→standard scenes Z” as a general release version to the reproduction order “standard scenes X→alternative scenes B→standard scenes Z” as a definitive version. Furthermore, as shown in FIG. 4, standard scenes Y, alternative scenes A, alternative scenes B, and alternative scenes C may have different lengths (different picture counts).

As described above, in MPEG4 AVC, information on the number of pictures in one GOVU needs to be written to the cpb_removal_delay in the leading picture of the succeeding picture. Thus, for the video content shown in FIG. 4, information on the number of pictures in GOVU preceding the leading GOVU of standard scenes Z, that is, information on the numbers of pictures in the last GOVU of standard scenes Y, in the last GOVU of alternative scenes A, in the last GOVU of alternative scenes B, and in the last GOVU of alternative scenes C, is described in the leading cpb_removal_delay in the leading GOVU of standard scenes Z.

Thus, the number of pictures needs to be same in all of the last GOVU of standard scenes Y, the last GOVU of alternative scenes A, the last GOVU of alternative scenes B, and the last GOVU of alternative scenes C. In other words, a process needs to be executed to set the number of pictures in each of the last GOVU of standard scenes Y, the last GOVU of alternative scenes A, the last GOVU of alternative scenes B, and the last GOVU of alternative scenes C equal to that described in the cpb_removal_delay for the leading picture in the leading GOVU of standard version Z. For convenience of description, this process is called a GOVU length adjusting process.

With reference to FIGS. 5, 6, and 7, description will be given of an encoding apparatus that implements the GOVU length adjusting process in accordance with an embodiment of the present invention.

FIG. 5 is an exemplary block diagram schematically showing the configuration of the encoding apparatus in accordance with the embodiment of the present invention. The encoding apparatus is implemented as an encoder 502. The encoder 502 is an apparatus that executes a process of compressing video data (video source). The encoder 502 comprises a GOVU configuration determining unit 504 and an encoding unit 506.

The GOVU configuration determining unit 504 receives various pieces of information such as parameters (for example, resolution and frame rate) set by the user, chapter point information, and I-picture insertion points. On the basis of the received information, the GOVU configuration determining unit 504 determines the GOVU configuration of video data and supplies information on the determined GOVU configuration to the encoding unit 506.

More specifically, the GOVU configuration determining unit 504 adjusts the number of pictures contained in the second last of a plurality of groups of video access units contained in each of the plurality of selectable content items (for example, standard scenes Y and alternative scenes A, B, and C, shown in FIG. 4) so that the last group of video access units contains a predetermined number of pictures. The determined GOVU configuration is supplied to the encoding unit 506 by the GOVU configuration determining unit 504.

The encoding unit 506 encodes the video data (video source) on the basis of the GOVU configuration determined by the GOVU configuration determining unit 504. More specifically, on the GOVU configuration supplied by the GOVU configuration determining unit 504, the encoding unit 506 executes a process of compressing video data to output a video bit stream and a log file. At this time, the encoding unit 506 inserts information on the number of pictures in the preceding GOVU into the cpb_removal_delay in the leading picture of the succeeding GOVU for encoding.

Unlike a compressing process executed in digital broadcasting, a compressing process executed to record video data on a medium such as DVD or HD DVD adopts a variable bit-rate scheme. The variable bit-rate scheme assigns a bit rate depending on the complexity of the video data to be processed. Such a process method is called a two-pass encode scheme. In general, a video bitstream resulting from the compressing process is reproduced and image quality is evaluated.

After the image quality evaluation, readjustment of parameters, bit rate, and the like is performed on scenes with compression distortion, and the compressing process is executed again. In the recompression process, instead of setting the number of pictures contained in the second last GOVU equal to the remainder, it is possible to set the number of pictures contained in GOVUs except the last and second last ones to be the remainder.

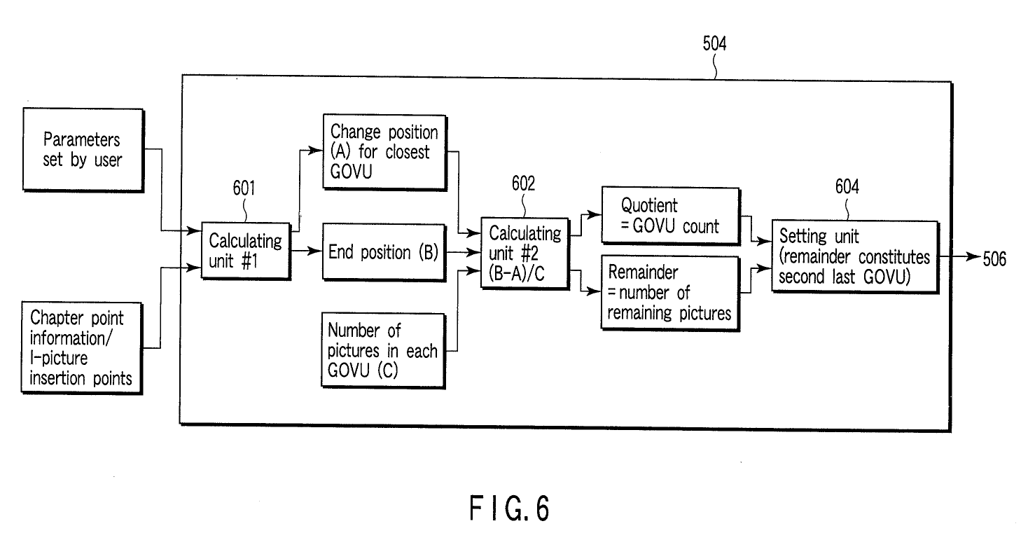

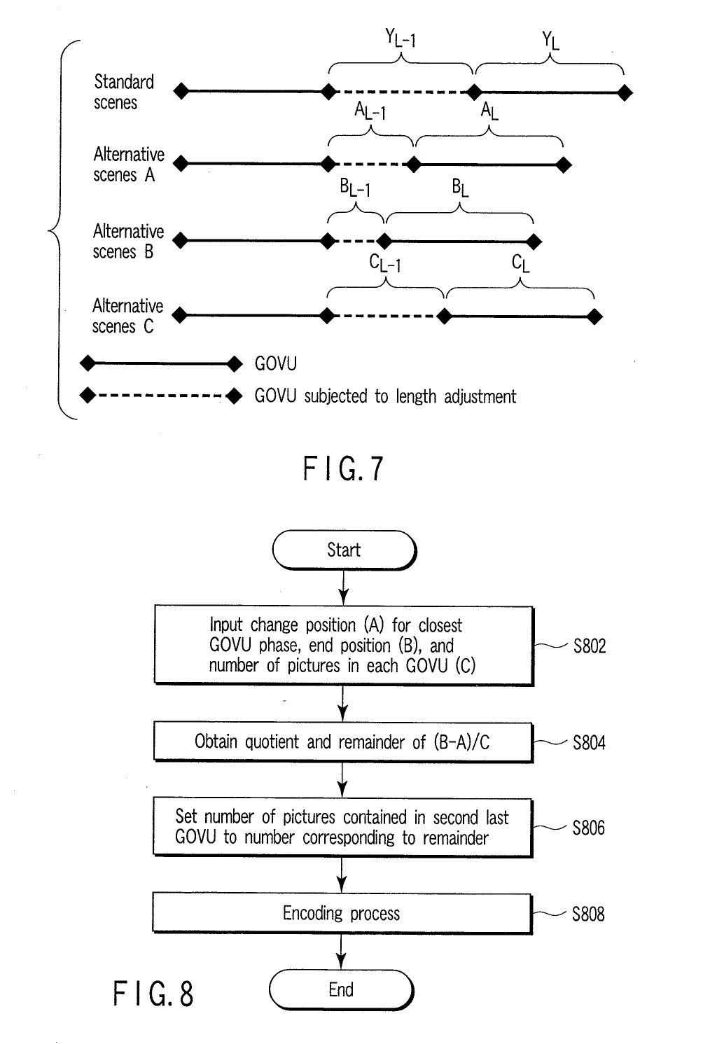

With reference to FIGS. 6 and 7, the GOVU configuration determining unit 504, shown in FIG. 5, will be described in further detail.

FIG. 6 is an exemplary block diagram schematically showing the configuration of the GOVU configuration determining unit 504. FIG. 7 is a schematic diagram illustrating the GOVU configuration of each alternative scenes determined by the GOVU configuration determining unit 504.

As shown in FIG. 6, the GOVU configuration determining unit 504 comprises a first calculating unit (#1) 601, a second calculating unit (#2) 602, and a setting unit 604. The first calculating unit 601 calculates required information from the parameters set by the user and the chapter point information/information on I-picture insertion points. As is the case with MPEG2, the number of pictures in GOVU is changed by the chapter points, I-picture insertion points specified by the user, or the like. A change position for the closest GOVU phase corresponds to any of these points.

The second calculating unit 602 receives information on a change position (A) for the phase of the closest GOVU, information on the end position (B) of the content, and information on the predetermined number of pictures (C) to be contained in a single GOVU. On the basis of the received information, the second calculating unit 602 the difference between the end position (B) of the content and the change position (A) for the closest GOVU phase by the predetermined number of pictures (C).

That is, the value of (B−A)/C is calculated. The calculation results in a quotient and a remainder. The quotient resulting from the calculation indicates the number of GOVUs contained in the content. The remainder resulting from the calculation indicates the number of remaining pictures. Of course, the number of the remaining pictures is smaller than the predetermined number of pictures (C).

The second calculating unit 602 outputs information of the quotient and the remainder to the setting unit 604. If no remainder has been obtained from the calculation (B−A)/C for the content (for example, alternative scenes A), all GOVUs in the content each contain the predetermined number of pictures. Consequently, reproduction poses no problem.

On the basis of information on the quotient and remainder supplied by the second setting unit 602, the setting unit 604 sets, for each of the plurality of selectable content items, the number of pictures contained in the second last GOVU to a value corresponding to the remainder output by the second calculating unit 602.

That is, the number of pictures contained in the second last GOVU is the same as the number of remaining pictures. Consequently, in each content item, all GOVUs except the second last one contain the same number of pictures (predetermined number of pictures [C]). Therefore, the number of pictures contained in the last GOVU is the same in the plurality of content items.

A process executed by the setting unit 604 will be described in further detail with reference to FIG. 7.

FIG. 7 is an exemplary schematic diagram illustrating the GOVU configuration of each content item determined by the setting unit 604 of the GOVU configuration determining unit 504. FIG. 7 assumes that a video content has a plurality of reproduction paths (selectable content), that is, a standard scenes and alternative scenes A, B, and C. As seen in FIG. 7, the standard scenes and alternative scenes A, B, and C have different lengths (different number of pictures). In FIG. 7, the solid line between the two rhombi denotes one GOVU, and the dotted line between two rhombi denotes GOVU on which length adjustment has been performed.

First, the GOVU configuration of standard scenes Y will be described. On the basis of information on the number (quotient) of GOVUs in standard scenes Y and the number (remainder) of remaining pictures of standard scenes Y, supplied by the second calculating unit 602, the setting unit 604 sets the number of pictures in the second last GOVU (YL-1) of standard scenes Y equal to the number of remaining pictures.

In other words, the number of pictures in the second last GOVU of standard scenes Y corresponds to the remainder resulting from the calculation executed by the second calculating unit 602. Consequently, the last GOVU (YL) contains the same number of pictures as that in each of all GOVUs of standard scenes Y except the second last one (YL-1). The second last GOVU (YL-1) contains pictures the number of which is different from the number of pictures in the other GOVUs.

The GOVU configurations of the alternative scenes will be described. On the basis of information on the number (quotient) of GOVUs in alternative scenes A and the number (remainder) of remaining pictures of alternative scenes A, supplied by the second calculating unit 602, the setting unit 604 sets the number of pictures in the second last GOVU (AL-1) of alternative scenes A equal to the number of remaining pictures.

In other words, the number of pictures in the second last GOVU of alternative scenes A corresponds to the remainder resulting from the calculation executed by the second calculating unit 602. Consequently, the last GOVU (AL) contains the same number of pictures as that in each of all GOVUs of alternative scenes A except the second last one (AL-1). The second last GOVU (AL-1) contains pictures the number of which is different from the number of pictures in the other GOVUs.

Likewise, on the basis of information on the number (quotient) of GOVUs in alternative scenes B and the number (remainder) of remaining pictures of alternative scenes B, supplied by the second calculating unit 602, the setting unit 604 sets the number of pictures in the second last GOVU (BL-1) of alternative scenes B equal to the number of remaining pictures. Consequently, the last GOVU (BL) contains the same number of pictures as that in each of all GOVUs of alternative scenes B except the second last one (BL-1). The second last GOVU (BL-1) contains pictures the number of which is different from the number of pictures in the other GOVUs.

Furthermore, on the basis of information on the number (quotient) of GOVUs in alternative scenes C and the number (remainder) of remaining pictures of alternative scenes C, supplied by the second calculating unit 602, the setting unit 604 sets the number of pictures in the second last GOVU (CL-1) of alternative scenes C equal to the number of remaining pictures. Consequently, the last GOVU (CL) contains the same number of pictures as that in each of all GOVUs of alternative scenes C except the second last one (CL-1). The second last GOVU (CL-1) contains pictures the number of which is different from the number of pictures in the other GOVUs.

Therefore, the setting unit 604 performs control such that the number of pictures is the same in all of the last GOVU (YL) of standard scenes Y, the last GOVU (AL) of alternative scenes A, the last GOVU (BL) of alternative scenes B, and the last GOVU (CL) of alternative scenes C are all the same.

On the other hand, the number of pictures may vary among the second last GOVU (YL-1) of standard scenes Y, the second last GOVU (AL-1) of alternative scenes A, the second last GOVU (BL-1) of alternative scenes B, and the second last GOVU (CL-1) of alternative scenes C. This is because in the buffer managing area of the leading picture of the leading GOVU of one content (for example, standard scenes Z, shown in FIG. 4), GOVU preceding the leading GOVU, that is, information on the number of pictures contained in the last GOVU of the preceding GOVU (for example, alternative scenes A, shown in FIG. 4) is stored; information on the number pictures contained in the second last GOVU is not stored in the buffer managing area.

As is apparent from the above description, to perform two-pass encoding on each of standard scenes X, Y, and Z and alternative scenes A, B, and C (see FIG. 4), the encoder 502 executes a process of adjusting the length of the second last GOVU for each of standard scenes Y and alternative scenes A, B, and C so that the length of the last GOVU (the number of pictures) has a predetermined value (the predetermined number of pictures).

Thus, if the video content has a plurality of reproduction paths (selectable content items), the encoder 502 can perform control such that the number of pictures is the same in all of the last GOVUs of the alternative scenes. Thus, whichever (for example, alternative scenes A) of the plurality of reproduction paths is selected, no problem occurs during the reproduction of the succeeding content (for example, standard scenes Z), resulting in seamless reproduction.

Now, an encoding method in accordance with an embodiment of the present invention will be described with reference to FIG. 8.

FIG. 8 is an exemplary flowchart illustrating the encoding method in accordance with the embodiment of the present invention. The encoding method is applicable to any apparatuses having a function for encoding video data. For convenience, in an example described below, the encoding method in accordance with the present embodiment is applied to the encoder 502, described above.

First, information on the change point (A) for the closest GOVU phase, information on the end point (B) of the content, and information on the predetermined number of pictures (C) to be contained in each GOVU are input to the encoder 502 (more specifically, the pieces of information are input to the GOVU configuration determining unit 504) (block S802).

Then, the difference between the end position (B) of the content and the change point (A) for the closest GOVU phase is divided by the predetermined number of pictures (C). That is, the encoder 502 (more specifically, the second calculating unit 602) calculates “(B−A)/C” to obtain the quotient and the remainder (block S804). If no remainder is obtained in block S804, the quotient alone may be determined. This is because if no remainder is obtained, all GOVUs in the content each contain the predetermined number of pictures, posing no reproduction problem.

The encoder 502 (more specifically, the setting unit 604) sets the number of pictures of a plurality of GOVUs contained in each of a plurality of content items of the video data and the second last GOVU to the number corresponding to the remainder (block S806).

That is, the encoder 502 executes a process of adjusting the length of the second last GOVU (the number of pictures) of the content. More specifically, the encoder 502 (more specifically, the setting unit 604) executes a process of adjusting the length of the second last GOVU for each of the plurality of reproduction paths (selectable content items) of the video content to perform control such that the number of pictures contained in the last GOVU is the same in all of the plural reproduction paths.

That is, the processing in blocks S802, S804, and S806 adjusts the number of pictures contained in the second last one of the plurality of GOVUs contained in each of the plurality of selectable content items in the video data. The GOVU configuration of the video data is thus determined so that the last GOVU has a predetermined number of pictures.

After the processing in block S806, the video data is encoded on the basis of the determined GOVU configuration (block S808).

If the video content has a plurality of reproduction paths (selectable content items), the above encoding method can perform control such that the number of pictures in the last GOVU is the same in all the reproduction paths. Thus, whichever (for example, alternative scenes A) of the plurality of reproduction paths is selected, the succeeding content (for example, standard scenes Z) can be seamlessly reproduced without posing any problem.

The above encoding method can also be implemented as a program that can be executed by a computer. Also in this case, the program can provide functions and effects similar to those provided by using the above encoding method.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An encoding apparatus configured to encode video data in accordance with the MPEG-4 Advanced Video Coding (AVC) specification, the encoding apparatus comprising:
a Group Of Video access Units (GOVU) configuration determining unit configured to determine a GOVU configuration of the video data such that a last one of a plurality of GOVUs contained in each of a plurality of selectable content items in the video data contains a predetermined number of pictures by adjusting the number of pictures contained in a penultimate GOVU; and
an encoding unit configured to encode the video data based on the GOVU configuration determined by the GOVU configuration determining unit.

2. The encoding apparatus according to claim 1, wherein the GOVU configuration determining unit comprises:
a calculating unit configured to receive information about a change position for the closest GOVU phase, information about an end position of a content item, and information about the predetermined number of pictures to be contained in each GOVU, the calculating unit being further configured to divide a difference between the end position of the content and the change position for the closest GOVU phase by the predetermined number of pictures, and to output a quotient and a remainder of the division; and
a setting unit configured to set the number of pictures contained in the penultimate GOVU to a number corresponding to the remainder output by the calculating unit.

3. The encoding device according to claim 1, wherein the encoding unit is configured to encode the video data by writing information about the number of pictures contained in one GOVU to a buffer management information area of a leading picture of the succeeding GOVU.

4. An encoding method for encoding video data in accordance with the MPEG-4 Advanced Video Coding; (AVC) specification, the encoding method comprising:
determining a Group Of Video access Units (GOVU) configuration of the video data such that a last one of a plurality of GOVUs contained in each of a plurality of selectable content items in the video data contains a predetermined number of pictures by adjusting the number of pictures contained in a penultimate GOVU; and
encoding the video data based on the GOVU configuration.

5. The encoding method according to claim 4, wherein the determining comprises:
receiving information about a change position for the closest GOVU phase, information about an end position of a content item, and information about the predetermined number of pictures to be contained in each GOVU;
dividing a difference between the end position of the content and the change position for the closest GOVU by the predetermined number of pictures;
outputting a quotient and a remainder of the division; and
setting the number of pictures contained in the penultimate GOVU to a number corresponding to the remainder.

6. The encoding method according to claim 4, wherein the encoding comprises encoding the video data by writing information about the number of pictures contained in one GOVU to a buffer management information area of a leading picture of the succeeding GOVU.
